(19) United States
(12) Patent Application Publication
(10) Pub. No.: US 2015/0312663 A1
(43) Pub. Date: Oct. 29, 2015

(54) SOURCE SEPARATION USING A CIRCULAR MODEL

(71) Applicant: ANALOG DEVICES, INC., Norwood, MA (US)

(72) Inventors: Johannes Traa, Urbana, IL (US); Paris Smaragdis, Urbana, IL (US)

(73) Assignee: ANALOG DEVICES, INC., Norwood, MA (US)

(21) Appl. No.: 14/440,211

(22) PCT Filed: Sep. 17, 2013
(86) PCT No.: PCT/US13/60044

§ 371 Date: May 1, 2015

Related U.S. Application Data
(60) Provisional application No. 61/702,993, filed on Sep. 19, 2012.

(51) Int. Cl. H04R 1/08; H04R 3/04

(52) U.S. Cl. CPC H04R 1/08; H04R 3/04; H04R 2430/00

(57) ABSTRACT

An approach to separating multiple sources exploits the observation that each source is associated with a linear-circular phase characteristic in which the relative phase between pairs of microphones follows a linear (modulo) pattern. In some examples, a modified RANSAC (Random Sample Consensus) approach is used to identify the frequency/phase samples that are attributed to each source. In some examples, either in combination with the modified RANSAC approach or using other approaches, a wrapped variable representation is used to represent a probability density of phase, thereby avoiding a need to “unwrap” phase in applying probabilistic techniques to estimating delay between sources.

### CROSS-REFERENCE TO RELATED APPLICATIONS

This application claims the benefit of U.S. Provisional Application No. 61/702,993 filed on Sep. 19, 2012, the entire contents of which is incorporated herein by reference.

### BACKGROUND

This invention relates to separating source signals.

Multiple sound sources may be present in an environment in which audio signals are received by multiple microphones. Localizing, separating, and/or tracking the sources can be useful in a number of applications. For example, in a multiple-microphone hearing aid, one of multiple sources may be selected as the desired source whose signal is provided to the user of the hearing aid. The better the desired source is identified in the microphone signals, the better the user's perception of the desired signal, hopefully providing higher intangibility, lower fatigue, etc.

Interaural phase differences (IPD) have been used for source separation since the 90's. It was shown in (Rickard, Yilmaz) that blind source separation is possible using just IPD's and interaural level differences (ILD) with the Degenerate Unmixing Estimation Technique (DUET). DUET relies on the condition that the sources to be separated exhibit W-disjoint orthogonality. This says that the energy in each time-frequency bin of the mixture's Short-Time Fourier Transform (STFT) is dominated by a single source. If this is true, the mixture STFT can be partitioned into disjoint sets such that only the bins assigned to the jth source are used to reconstruct it. The bin assignments are known as binary masks. In theory, as long as the sources are W-disjoint orthogonal, perfect separation can be achieved. Good separation can be achieved in practice even though speech signals are only approximately orthogonal.

### SUMMARY

In one aspect, in general, an approach to separating multiple sources exploits the observation that each source is associated with a linear-circular phase characteristic in which the relative phase between pairs of microphones follows a linear (modulo 2π) pattern. In some examples, a modified RANSAC (Random Sample Consensus) approach is used to identify the frequency/phase samples that are attributed to each source. In some examples, either in combination with the modified RANSAC approach or using other approaches, a wrapped variable representation is used to represent a probability density of phase, thereby avoiding a need to “unwrap” phase in applying probabilistic techniques to estimating delay between sources.

In examples, in which modified RANSAC (Random Sample Consensus) is applied to fit multiple wrapped lines to circular-linear data, the approach can have an advantage of avoiding issues with local maxima where optimization strategies (i.e. EM, gradient descent) will fail (there may be many (50+%) outliers present in the data and lines may cross over each other).

In some examples, the modified RANSAC approach is applied to perform source separation by treating the phase differences (IPD) between two or more microphones as wrapped variables. Once wrapped lines are fit to the IPD data, the signals are separated by constructing a probabilistic (soft) mask or a binary mask from the data and the lines. Since the lines correspond to directions of arrival (DOA) of the source signals in physical space, they can be validated to ensure that the model fit by RANSAC doesn't violate the laws of wave propagation. This is done by forcing the model estimates to lie on the manifold of physically possible inter-microphone delays. In this way, RANSAC can be applied to source separation as well as source localization in 2D and 3D with an arbitrary number of microphones.

In another aspect, in general, a method for separating source signals from a plurality of sources uses a plurality of sensors. A first signal is accepted at each of the sensors. The first signal includes a combination of multiple of the source signals and each sensor provides a corresponding first sensor signal representing the first signal. For each of a set of pairs of sensors, phase values are determined for a plurality of frequencies of the pair of the first sensor signals provided by the pair of sensors, and a parametric relationship between phase and frequency for each of a plurality of signal sources included in the sensor signals is estimated. The parametric relationship characterizes a periodic distribution of phase at each frequency for each source. A second signal is accepted at each of the sensors, each sensor providing a corresponding second sensor signal representing the second signal. For each of a set of pairs of sensors, phase values for a plurality of frequencies of the pair of the second sensor signals accepted at the pair of sensors are determined. A frequency mask is formed corresponding to a desired source of the plurality of sources from the determined phase values of the second sensor signals and the periodic distribution of phase characterized by the parametric relationships estimated from the first signals.

Aspects may include one or more of the following features.

The method further includes combining at least one of the second sensor signals and the frequency mask to determine an estimate of a source signal received at the sensors from the selected one of the sources.

The sources comprise acoustic signal sources and the sensors comprise microphones and the first sensor signals and the second sensor signals each includes a representation of an acoustic signal received from the selected source at the microphones.

Estimating the parametric relationship between phase and frequency includes applying an iteration. Each iteration includes generating a set of candidate parameters, and selecting a best parameter from the candidate parameters according to a degree to which a parametric relationship with said parameter accounts for the determined phase values.

Applying the iteration includes, at each of at least some of the iterations, selecting the best parameter according to a degree to which a parametric relationship with said parameter accounts for determined phase values not accounted for according to parameters of prior iterations.

In some examples, estimating the parametric relationship between phase and frequency includes estimating a linear relationship. In some examples, estimating the parametric relationship between phase and frequency includes estimating a parametric curve relationship. For instance, estimating a parametric curve relationship includes estimating a spline relationship.

Forming the frequency mask includes forming a binary frequency mask.

Estimating the parametric relationships comprises applying a RANSAC (Random Sample Consensus) procedure.

Other features and advantages of the invention are apparent from the following description, and from the claims.

### DESCRIPTION OF DRAWINGS

FIG. 1 is a diagram of a source localization and estimation system.

FIG. 2 show a relationship of relative phase and frequency with multiple sources.

### DESCRIPTION

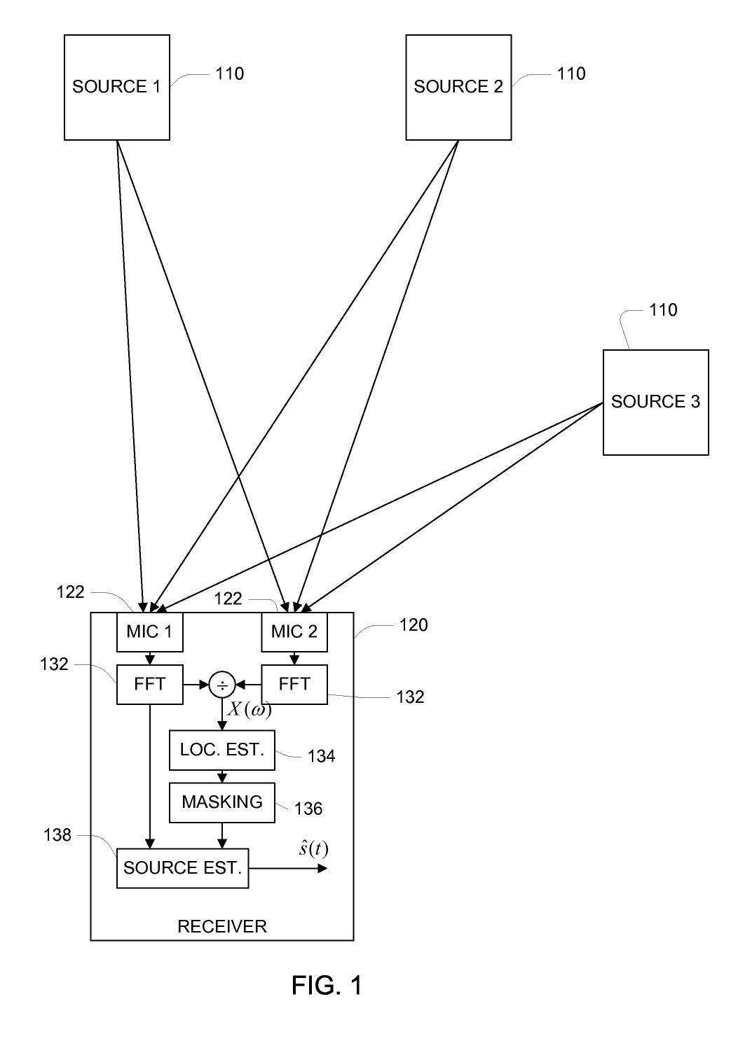

Referring to FIG. 1, in one example implementation, three audio sources 110 are distributed in a space in which a receiver 120 received signals from the sources at two microphones 122 (i.e., audio sensors). Each of the microphone signals is transformed into the frequency domain, for example, using a Short Time Fourier Transform (STFT) implemented in a Fast Fourier Transform (FFT) block 132. The complex frequency components of the transformed signals are divided, yielding a relative frequency domain complex signal X(ω). In the discussion below, x(ω)=∠X(ω), the phase of the frequency domain signal at frequency ω, where x(ω)∈[0, 2π).

If there is only a single source, say source 1, and the difference in signal propagation delay from the source to microphone 1 and source to microphone 2 is τ, then the phase x(ω) is concentrated on a wrapped line x=τωmod2π where τ is in seconds, and ω is in radians per second. The phase is not exactly on a line due to factors including noise in the microphone signals and differences in the transfer function from the source to the two microphones not purely due to delay. In a discrete domain, each STFT yields a set of data points (xᵢ, yᵢ), where the yᵢ are scaled versions of corresponding frequencies ωᵢ. Combining the data points from multiple STFTs yields a sample distribution in phase which is concentrated near the line xᵢ=ayᵢ mod 2π, where a is a multiple of the delay τ.

In some discussion below, rather than referring to the delay variable a, an equivalent direction of arrival that satisfies θ=sin⁻¹(a/πm) is used, where θ∈[−π, π) and m is suitably chosen so that −1≦a/πm≦1. However, it should be understood that because of the 1-1 relationship between the two variables, either can be used, and in the derivations and examples below, setting or determining one of the two variables should be understood to correspond to setting or determining of the other of the two variables as well.

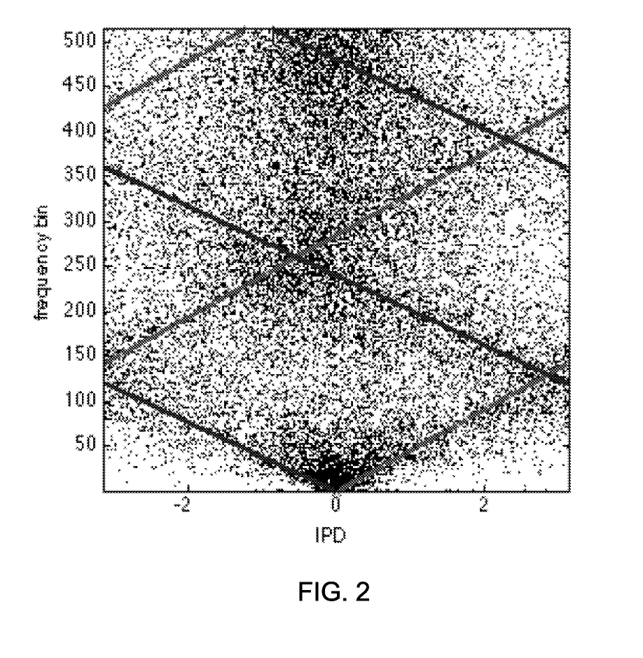

Referring to FIG. 2, an example of the sample distribution in a simulation for two audio sources in reverberant environment is shown where the phase (x) axis is illustrated in the range x∈[−π,π] and labeled “IPD”, and the frequency axis is in units of frequency bins of a Discrete Fourier Transform. Lines characterizing the relative delays for the two sources, shows that the data samples are indeed somewhat concentrated near the lines.

A probabilistic model is used to characterize the data in FIG. 2. In particular, at any frequency y, and a particular source i with delay variable aᵢ, the probability density of the phase is assumed to take the form p(x|y, aᵢ)∝exp(k cos(x−aᵢy)). Note that due to the periodic nature of cos( ), the term aᵢy can be replaced, for example for numerical reasons, with aᵢymod2π or (aᵢy+π)mod2π−π, without changing p(x|y,aᵢ). Note that exp(k cos(x−aᵢy)) is unimodal with a peak of exp(k) at x=aᵢy. The integral of exp(k cos(x−aᵢy)) over any interval of 2π in x is 2πI₀(k) where I₀(k) is the zeroth order Bessel function of the first kind. With N equally likely sources the distribution can be considered to be a mixture distribution such that

$$p ( x \vert y ) ∝ {\sum }_{n = 1}^{N} \frac{1}{N} p ( x \vert y , {a}_{i} ) = {\sum }_{i = 1}^{N} \frac{1}{N} exp ( k cos ( x - {a}_{i} y ) ) .$$

Note that other forms functions p(x|y,aᵢ)∝G(x−aᵢy) where G(x) has a period 2π, with a unimodal peak at x=0, can equivalently be used.

A number of procedures are combined in order to form a desired signal that approximates the signal received from the desired source. The processes include the following:
Estimation of the parameters aₖ for sources k=1, . . . , K.
Forming of a frequency mask based on a selected source and the estimated source parameters
Reconstruction of the estimate of the desired source signal.

One approach to estimation of the parameters aₖ for sources k=1, . . . , K, which characterize the directions of arrival of the sources, makes use of an iterative approach in which points (xᵢ, yᵢ) points are assigned to sources as follows. For a given line x=ay, points (xᵢ, yᵢ) are “inliers” to that line if they are in proximity to the line defined in one of the following ways:
p(xᵢ|yᵢ,a)≧p₀ for some threshold p₀
cos(xᵢ−ayᵢ)≧c₀ for some threshold c₀ (e.g., p₀=exp(kc₀))
   |(xᵢ−ayᵢ+π mod 2π)−π|≦z₀ for some threshold z₀ (e.g., cos(z₀)=c₀)

In some examples, the inliers may be defined by making p₀ be a fixed fraction (e.g., ½) of the maximum value of the density. In some examples, a phase range specifies the inlier range, for example, as z₀=π/16.

Generally, a quality of a match of a line to the sample data can be measured by the fraction (or number) of inlier points to the line. A higher quality line accounts for a larger fraction of the sample data.

One procedure for identifying the delays (i.e., slopes of lines) represented in a data set D={<xᵢ, yᵢ>} of phase/frequency pairs identifies K sources as follows:
For k=1, . . . , K
   Select M random samples from D;
   For m=1, . . . , M
      Choose θ_{k,m} corresponding to the slope a=x|y for that m^{th} random sample;
      Over the full data set D, count the number of inliers;
   Set \hat{θ}ₖ to be the θ_{k,m} with the highest inlier count;
   Remove the inlier data from D;
      The result of this procedure is a set of source parameters (i.e., directions of arrival) \hat{θ}₁, . . . , \hat{θ}_{K}.

Given the estimated source parameters, an approach to source separation involved determining a mask that identifies frequencies at which a desired source is present. Note that as described above, the source parameters the probability of a phase/frequency pair xᵢ, yᵢ conditioned on the source can be used to yield the posterior probability that the phase/frequency pair comes from that source as follows:

$$Pr ( source k \vert {x}_{i} , {y}_{i} ) = \frac{p ( {x}_{i} \vert {y}_{i} , {a}_{k} ) Pr ( {a}_{k} \vert {y}_{i} )}{p ( {x}_{i} \vert {y}_{i} )}$$

Under certain assumptions (e.g., that all sources are equally likely to be present at each frequency a priori), this permits computing the probability that the a data point a frequency yᵢ, with phase xᵢ comes from the n^{th} source as

$$Pr ( source n \vert frequency {y}_{i} ) = \frac{exp ( k cos ( {x}_{i} - {a}_{n} {y}_{i} ) )}{{\sum }_{k = 1}^{K} exp ( k cos ( {x}_{i} - {a}_{k} {y}_{i} ) )}$$

One of two masking approaches can be used. A “hard” mask may be chosen such that

$${m}_{i} = \{ \begin{matrix}1 & if i = {argmax}_{k} Pr ( source k \vert frequency i ) \\ 0 & otherwise\end{matrix} .$$

Alternatively, a “soft” mask may be used such that

mᵢ=Pr(source \hat{k}|frequency i)

where \hat{k} is the index of the desired source. Note that in the distributional form, as the parameter k, a hardness of the soft mask is increased by concentrating the distribution near the line corresponding to each source.

An alternative embodiment relaxes the assumption that the phase difference between microphones is proportional to frequency, or equivalently that the <xᵢ, yᵢ> points for a source line on a straight line in the wrapped space. A variety of factors can affect such deviation from a straight line, although one should understand that these factors may not be present in all cases and that other factors may affect the shape of the relationship. One factor is that the multiple microphones may have somewhat different phase response as a function of frequency. Therefore, the difference in the phase responses will manifest as deviation from a straight line. Another factor is reverberation, which may also manifest as deviation from an ideal straight line.

One approach to relaxing the straight-line assumption is to use a spline approximation, for example, using a cubic spline with a fixed number of knots at variable frequencies. One way to introduce the spline approximations into the procedure is to first follow the procedure described above to determine the straight-line parameters aₖ for the K sources k=1, . . . , K. These straight line parameters are then used to initialize the unknown parameters of the splines. Each spline is assumed to have M knots, and therefore have M−1 cubic sections, each with four unknown parameters of the cubic polynomial. Constraints at the interior M−2 knots guarantee continuity of value and first and second derivatives at the knots. An iterative procedure is then used to update the spline parameters to better match the data.

One iterative approach make use of an Estimate-Maximize (EM) algorithm approach. Specifically, for a particular source k, the parameterize spline y=fₖ(x) defines the mode of phase distribution. The distribution is modeled using a wrapped Gaussian defined as

$$𝒲𝒩 ( y ; μ , {σ}^{2} ) ≡ {\sum }_{l = - ∞}^{∞} 𝒩 ( y ; μ + 2 π l , {σ}^{2} ) , - π \leq y \leq π ,$$

such that

P(yᵢ|k)=WN(yᵢ;fₖ(xᵢ),σₖ²).

In the iterative procedure, in each “E” step, each data pair <xᵢ, yᵢ> is fractionally associated with a source k and wrap index l according to

$${w}_{ikl} = \frac{𝒩 ( {y}_{i} ; {f}_{k} ( {x}_{i} ) + 2 π l , {σ}_{k}^{2} )}{{\sum }_{m = - ∞}^{∞} 𝒩 ( {y}_{i} ; {f}_{k} ( {x}_{i} ) + 2 π m , {σ}_{k}^{2} )} = \frac{𝒩 ( {y}_{i} ; {f}_{k} ( {x}_{i} ) + 2 π l , {σ}_{k}^{2} )}{𝒲𝒩 ( {y}_{i} ; {f}_{k} ( {x}_{i} ) , {σ}_{k}^{2} )}$$

Note that these weights, wᵢₖₗ are coupled to the parameters of the spline functions fₖ(x), which is a reason that the estimation of the spline parameters is performed in this iterative manner.

In the “M” step, the fractionally weighted data pairs are used to update the spline parameters according to conventional techniques. In some examples, the variances are fixed at unity (σₖ=1.0) or at some other fixed values. The parameters \hat{θ}₁, . . . , \hat{θ}_{K} represent the parameters of the K spline fits.

At the end of the iteration, soft mask values at a frequency xᵢ with an observed phase yᵢ at that frequency may be computed using a posterior probability approach similar to that described previously as

$$Pr ( source n \vert frequency {y}_{i} ) = \frac{𝒲𝒩 ( {y}_{i} ; {f}_{n} ( {x}_{i} ) , {σ}_{n}^{2} )}{{\sum }_{k = 1}^{K} 𝒲𝒩 ( {y}_{i} ; {f}_{k} ( {x}_{i} ) , {σ}_{k}^{2} )}$$

Referring again to FIG. 1, after determining the source parameters \hat{θ}₁, . . . , \hat{θ}_{K} in block 134 as described above, and selecting a desired source \hat{k}, for example, as \hat{k}=1, which corresponds to the source that accounts for the greatest number of points, of the source k that accounts for the greatest energy, or applying other probabilistic or heuristic selection for the source, the mask m is formed in block 136 using any one of the approaches described above. Then this mask is passed to a source estimation block 138, which modifies each STFT received from a Fourier Transform block 132 for one of the microphones (e.g., Microphone 1) prior to reconstruction of a time signal, for example, using a conventional overlap-add technique. For example, windowed 1024 point STFT's are computed with a widow hop size of 256.

It should be understood that the approach described above can be extended to more than two microphones, thereby allowing localization in three dimensions or enhanced localization in two dimensions.

The approach can be applied to multiple microphones, defining a (or θ), x, and y as a vectors (e.g., dimension 2 for three microphones). Various forms of distribution may be used, for example, assuming the dimensions are independent and using a product of the densities over the dimensions.

For localization in two dimensions using more than two microphones arranged in along a line, each data sample associates a frequency with a tuple of relative phases. For each source, the slopes of the phase vs. frequency lines are related according to the coordinates of the microphones. Therefore, the procedure described above for the two-microphone case can be extended by defining an “inlier” to depend on all the relative phases observed. For example, the relatively phases must be sufficiently near the estimated line for all the relative phases measured, or the product of the probabilities (e.g., the sum of the exponent terms k cos(xᵢ−ayᵢ)) must be above a threshold. In forming the masks, and in particular in forming the soft masks, a combination (e.g., product) of the probabilities determined for each of the relative phase measurements are combined.

When the three or more microphones are not arranged along a line, localization in more than two dimensions can be performed. The procedure described above is again modified but each line for the relative phase between a pairs of microphones now depends two direction parameters rather than one.

Other prior information regarding probability of source given frequency may also be included, for example, in addition or instead of the prior information based on tracking over time. In the approach described above for forming a soft mask for isolating the desired source, an assumption that is made is that the prior probability for each source, and more particularly, the prior probability for each source at each frequency are fixed, and in particular are equal. Other situations, other information is available for separating the sources such that Pr(source k), or Pr(source k|frequency i). These sources of information can be combined with the phase-based quantities in determining the masks. An example of such a source of information includes a tracking (recognition) of the spectral characteristics of each source, for example, according to a speech production model, such that past spectral characteristics for a source provide information about the presence of that source's signal in each of the frequency bins at a current window where the source time signal is being reconstructed.

Another source of prior information relates to locations of the sources. For example, at any time, a prior probability distribution for source locations can be combined with the conditional probabilities of the frequency/phase samples (e.g., a mixture distribution form introduced above) given the locations to yield a Bayesian estimate (e.g., a posterior distribution) of the source locations. Similarly, source locations may be tracked by including a model of movement of sources (e.g., random walks) for prediction and the frequency/phase samples for updating of the source locations, for example, using a Kalman Filtering or similar approach.

Applications of the approaches described above are not restricted to those described (e.g., for hearing aids). For example, multiple microphone audio input systems for automated audio processing and/or transmission may similarly use the approach. An example of such an application is a tablet computer, smartphone, or other portable device that has multiple microphones, for example, at four corners of the body of the device. One (or more) source can be selected for processing (e.g., speech recognition) or transmission (e.g., for audio conferencing) from the device using the approaches described above. Other examples arise in fixed configurations, for example, for a microphone array in a conference room. In some such examples, prior knowledge of locations of desirable sources (e.g., speakers seated around a conference table) can be incorporated into the estimation procedure.

Embodiments of the approaches described above may be implemented in software, in hardware, or a combination of software and hardware. Software can include instructions (e.g., machine instructions, higher level language instructions, etc.) stored on a tangible computer readable medium for causing a processor to perform the functions described above.

It is to be understood that the foregoing description is intended to illustrate and not to limit the scope of the invention, which is defined by the scope of the appended claims. Other embodiments are within the scope of the following claims.

What is claimed is:

1. A method for separating source signals from a plurality of sources using a plurality of sensors, the method comprising:
accepting a first signal at each of the sensors, the first signal including a combination of multiple of the source signals, each sensor providing a corresponding first sensor signal representing the first signal;
for each of a set of pairs of sensors,
determining phase values for a plurality of frequencies of the pair of the first sensor signals provided by the pair of sensors, and
estimating a parametric relationship between phase and frequency for each of a plurality of signal sources included in the sensor signals, the parametric relationship characterizing a periodic distribution of phase at each frequency for each source;
accepting a second signal at each of the sensors, each sensor providing a corresponding second sensor signal representing the second signal;
for each of a set of pairs of sensors,
determining phase values for a plurality of frequencies of the pair of the second sensor signals accepted at the pair of sensors; and
forming a frequency mask corresponding to a desired source of the plurality of sources from the determined phase values of the second sensor signals and the periodic distribution of phase characterized by the parametric relationships estimated from the first signals.

2. The method of claim 1 further comprising combining at least one of the second sensor signals and the frequency mask to determine an estimate of a source signal received at the sensors from the selected one of the sources.

3. The method of claim 1 wherein the sources comprise acoustic signal sources and the sensors comprise microphones.

4. The method of claim 3 wherein the first sensor signals and the second sensor signals each includes a representation of an acoustic signal received from the selected source at the microphones.

5. The method of claim 1 wherein estimating the parametric relationship between phase and frequency includes:
applying an iteration, each iteration including generating a set of candidate parameters, and selecting a best parameter from the candidate parameters according to a degree to which a parametric relationship with said parameter accounts for the determined phase values.

6. The method of claim 5 wherein applying the iteration includes, at each of at least some of the iterations, selecting the best parameter according to a degree to which a parametric relationship with said parameter accounts for determined phase values not accounted for according to parameters of prior iterations.

7. The method of claim 1 wherein estimating the parametric relationship between phase and frequency includes estimating a linear relationship.

8. The method of claim 1 wherein estimating the parametric relationship between phase and frequency includes estimating a parametric curve relationship.

9. The method of claim 8 wherein estimating a parametric curve relationship includes estimating a spline relationship.

10. The method of claim 1 wherein forming the frequency mask includes forming a binary frequency mask.

11. The method of claim 1 wherein estimating the parametric relationships comprises applying a RANSAC (Random Sample Consensus) procedure.

12. A signal processing system comprising:
an plurality of sensor inputs, each for coupling to a corresponding one of a plurality of sensor and accepting a corresponding sensor signal;
a computer-implemented processing module configured to, for each of a set of pairs of sensor signals,
determine phase values for a plurality of frequencies of the pair of first sensor signals accepted at the sensor inputs, and
estimate a parametric relationship between phase and frequency for each of a plurality of signal sources represented in the first sensor signals, the parametric relationship characterizing a periodic distribution of phase at each frequency for each source,
determine phase values for a plurality of frequencies of the pair of second sensor signals accepted at the sensor inputs; and
wherein the processing module is further configured to form and store a frequency mask corresponding to a desired source of the plurality of sources from the determined phase values of the second sensor signals and the periodic distribution of phase characterized by the parametric relationships estimated from the first signals.

13. The system of claim 12 wherein the processing module is further configured to combine at least one of the second sensor signals and the frequency mask to determine an estimate of a source signal received at the sensors from the selected one of the sources.

14. Software stored on a non-transitory machine-readable medium comprising instructions for causing a signal processor to:
accept sensor signals at a plurality of sensor inputs;
for each of a set of pairs of sensor signals,
determine phase values for a plurality of frequencies of the pair of first sensor signals accepted at the sensor inputs, and
estimate a parametric relationship between phase and frequency for each of a plurality of signal sources represented in the first sensor signals, the parametric relationship characterizing a periodic distribution of phase at each frequency for each source,
determine phase values for a plurality of frequencies of the pair of second sensor signals accepted at the sensor inputs; and
to form and store a frequency mask corresponding to a desired source of the plurality of sources from the determined phase values of the second sensor signals and the periodic distribution of phase characterized by the parametric relationships estimated from the first signals.

15. The system of claim 14 wherein the instructions are further for causing the signal processor to combine at least one of the second sensor signals and the frequency mask to determine an estimate of a source signal received at the sensors from the selected one of the sources.
